(19) United States
(12) Patent Application Publication
(10) Pub. No.: US 2025/0227543 A1
(43) Pub. Date: Jul. 10, 2025

(54) SIGNALING CHANGES IN QOS CHARACTERISTICS

(71) Applicants: Dibakar Das, Hillsboro, OR (US); Susruth Sudhakaran, Beaverton, OR (US); Danny Ben-Ari, Tsur Natan (IL); Laurent Cariou, Milizac (FR); Necati Canpolat, Beaverton, OR (US); Javier Perez-Ramirez, North Plains, OR (US); Dave A. Cavalcanti, Portland, OR (US)

(72) Inventors: Dibakar Das, Hillsboro, OR (US); Susruth Sudhakaran, Beaverton, OR (US); Danny Ben-Ari, Tsur Natan (IL); Laurent Cariou, Milizac (FR); Necati Canpolat, Beaverton, OR (US); Javier Perez-Ramirez, North Plains, OR (US); Dave A. Cavalcanti, Portland, OR (US)

(21) Appl. No.: 19/094,474

(22) Filed: Mar. 28, 2025

Related U.S. Application Data
(60) Provisional application No. 63/631,915, filed on Apr. 9, 2024.

(51) Int. Cl. H04W 28/02

(52) U.S. Cl. CPC H04W 28/0268

(57) ABSTRACT

Methods, apparatuses, and computer readable media for signaling changes in quality of service (QoS) characteristics includes processing circuitry configured to: encode, for transmission to an access point (AP), a stream classification service (SCS) request frame, the SCS request frame comprising a SCS descriptor element, the SCS descriptor element including an SCS identification (ID), an indication of a request to add, and a QoS characteristics element, decode, from the AP, a SCS response frame, the SCS response frame including the SCS ID and an indication that an SCS stream with the SCS identification is successfully added, decode, from the AP, a trigger frame, the trigger frame comprising uplink (UL) resource units for the STA, encode, for transmission to the AP, a frame in accordance with the UL resource units, data, and encode, for transmission to the AP, an indication of a change of traffic characteristics.

### PRIORITY CLAIM

This application claims the benefit of priority under 35 USC 119(e) to U.S. Provisional Patent Application Ser. No. 63/631,915, filed Apr. 9, 2024 [reference number AG0563-Z], which is incorporated herein by reference in its entirety.

### TECHNICAL FIELD

Embodiments relate to signaling changes in quality of service (QoS) characteristics, in accordance with wireless local area networks (WLANs) and Wi-Fi networks including networks operating in accordance with different versions or generations of the IEEE 802.11 family of standards.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with newer protocols and with legacy protocols on multiple bands and channels.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates a front-end module circuitry for use in the radio architecture of FIG. 1 in accordance with some embodiments;

FIG. 3 illustrates a radio IC circuitry for use in the radio architecture of FIG. 1 in accordance with some embodiments;

FIG. 4 illustrates a baseband processing circuitry for use in the radio architecture of FIG. 1 in accordance with some embodiments;

FIG. 5 illustrates a WLAN in accordance with some embodiments;

FIG. 6 illustrates a block diagram of an example machine upon which any one or more of the techniques (e.g., methodologies) discussed herein may perform;

FIG. 7 illustrates a block diagram of an example wireless device upon which any one or more of the techniques (e.g., methodologies or operations) discussed herein may perform;

FIG. 8 illustrates multi-link devices (MLD)s, in accordance with some embodiments;

FIG. 9 illustrates a quality of service (QoS) characteristics element, in accordance with some embodiments;

FIG. 10 illustrates a graph of a trace of UL traffic corresponding to slide-sharing during a video call;

FIG. 11 illustrates a graph of a trace collected for the UL traffic during a steam of a first-person shooter (FPS) game when there is lots of motion followed by no motion of the user within the virtual world;

FIG. 12 illustrates a histogram of burst packet generation in UL carrying camera images, in accordance with some embodiments;

FIG. 13 illustrates a SCS descriptor element, in accordance with some embodiments;

FIG. 14 illustrates a QoS report element, in accordance with some embodiments;

FIG. 15 illustrates an example method for signaling changes in QoS characteristics, in accordance with some embodiments;

FIG. 16 illustrates a method for signaling changes in QoS characteristics, in accordance with some embodiments;

FIG. 17 illustrates a method for signaling changes in QoS characteristics, in accordance with some embodiments;

FIG. 18 illustrates an A-control field, in accordance with some embodiments;

FIG. 19 illustrates control information, in accordance with some embodiments;

FIG. 20 illustrates control information, in accordance with some embodiments;

FIG. 21 illustrates a method for signaling changes in QoS characteristics, in accordance with some embodiments;

FIG. 22 illustrates a method for signaling changes in QoS characteristics, in accordance with some embodiments;

FIG. 23 illustrates a method for signaling changes in QoS characteristics, in accordance with some embodiments; and

FIG. 24 illustrates a method for signaling changes in QoS characteristics, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

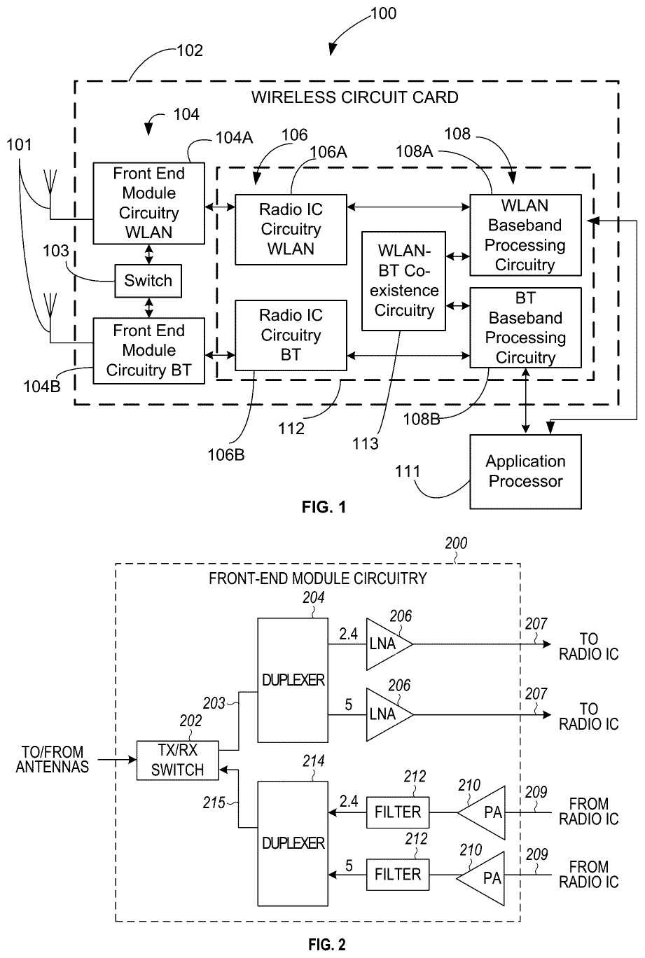

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth® (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth® (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth® (BT) connectivity standard such as Bluetooth®, Bluetooth® 4.0 or Bluetooth® 5.0, or any other iteration of the Bluetooth® Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about nine hundred MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHz signal paths and may utilize the same FEM circuitry 200 as the one used for WLAN communications.

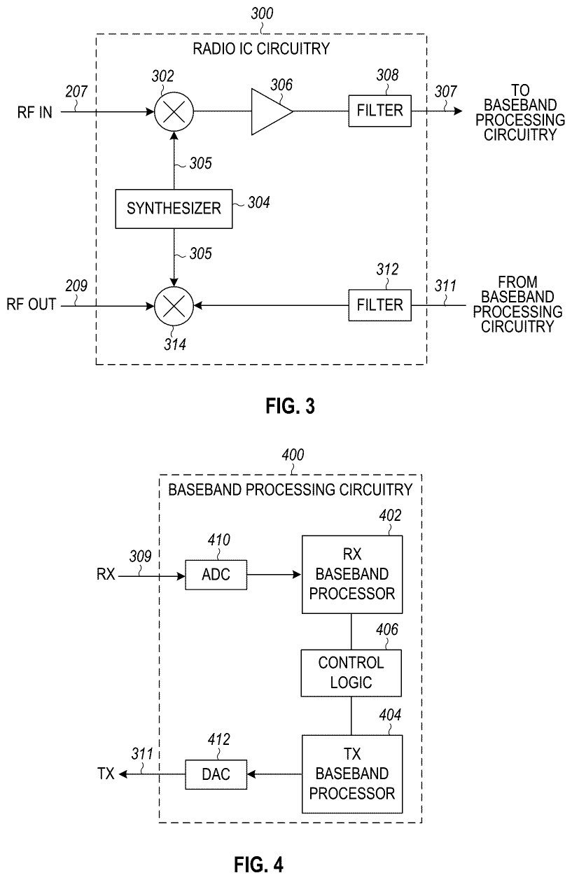

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the TX BBP 404 may be configured to generate OFDM or OFDMA signals as appropriate for transmission by performing an inverse fast Fourier transform (IFFT). The RX BBP 402 may be configured to process received OFDM signals or OFDMA signals by performing an FFT. In some embodiments, the RX BBP 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

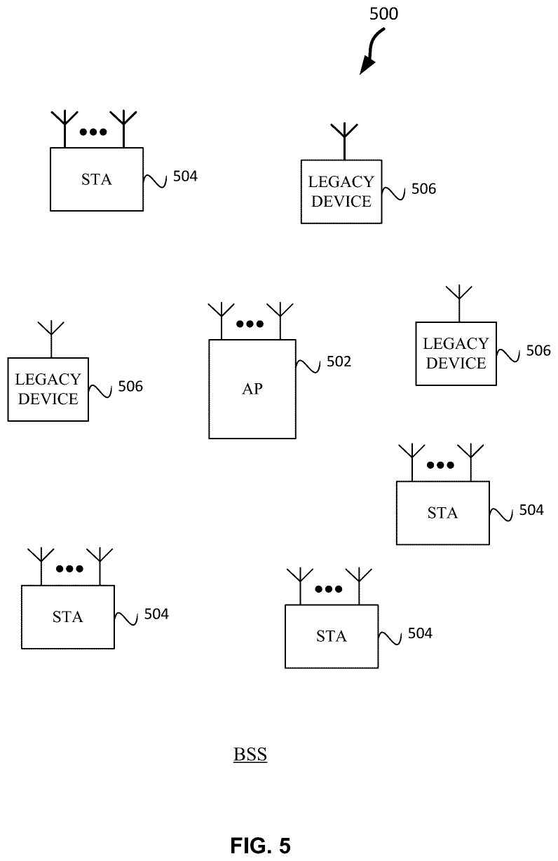

FIG. 5 illustrates a WLAN 500 in accordance with some embodiments. The WLAN 500 may comprise a basis service set (BSS) that may include an access point (AP) AP 502, a plurality of stations (STAs) STAs 504, and a plurality of legacy devices 506. In some embodiments, the STAs 504 and/or AP 502 are configured to operate in accordance with IEEE 802.11be extremely high throughput (EHT), WiFi 8 IEEE 802.11 ultra-high throughput (UHT), high efficiency (HE) IEEE 802.11ax, IEEE 802.11bn next generation or ultra-high reliability (UHR), and/or another IEEE 802.11 wireless communication standard. In some embodiments, the STAs 504 and/or AP 502 are configured to operate in accordance with IEEE P802.11be, and/or IEEE P802.11-REVme™, both of which are hereby included by reference in their entirety, and to operate in accordance with one or more functions described herein.

The AP 502 may use other communications protocols as well as the IEEE 802.11 protocol. The terms here may be termed differently in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax/uht, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the AP 502 may also be configured to communicate with STAs 504 in accordance with legacy IEEE 802.11 communication techniques.

In some embodiments, a HE, EHT, UHT frames may be configurable to have the same bandwidth as a channel. The HE, EHT, UHT frame may be a physical Layer Convergence Procedure (PLCP) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, downlink (DL) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE, EHT, UHT, UHT, or UHR frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, low-power Bluetooth®, or other technologies.

In accordance with some IEEE 802.11 embodiments, e.g., IEEE 802.11EHT/ax/be embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE, EHT, UHR control period, the AP 502 may communicate with STAs 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or STAs 504 in accordance with legacy IEEE 802.11 communication techniques. In some embodiments, the AP 502 may also be configurable to communicate with STAs 504 outside the TXOP in accordance with legacy IEEE 802.11 or IEEE 802.11EHT/UHR communication techniques, although this is not a requirement.

In some embodiments the STA 504 may be a “group owner” (GO) for peer-to-peer modes of operation. A wireless device may be a STA 504 or a HE AP 502. The STA 504 may be termed a non-access point (AP) (non-AP) STA 504, in accordance with some embodiments.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE STA 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-24.

In example embodiments, the STAs 504 and/or the AP 502 are configured to perform the methods and operations/functions described herein in conjunction with FIGS. 1-24. In example embodiments, an apparatus of the STA 504 and/or an apparatus of the AP 502 are configured to perform the methods and functions described herein in conjunction with FIGS. 1-24. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP. The AP 502 may be part of, or affiliated with, an AP MLD 808, e.g., AP1 830, AP2 832, or AP3 834. The STAs 504 may be part of, or affiliated with, a non-AP MLD 809, which may be termed a ML non-AP logical entity. The BSS may be part of an extended service set (ESS), which may include multiple APs, access to the internet, and may include one or more management devices.

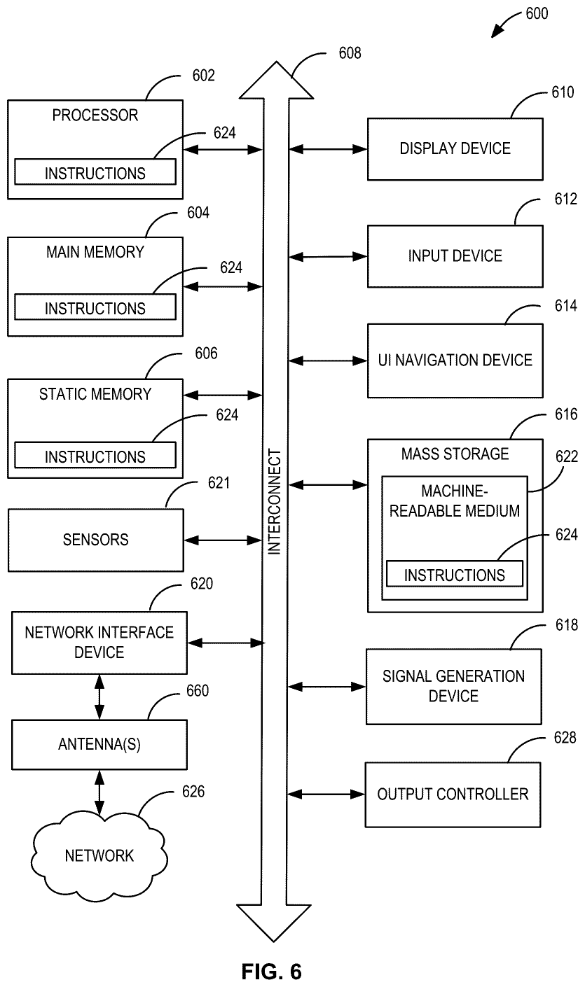

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT STA 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The mass storage 616 device may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the mass storage 616 device may constitute machine readable media.

Specific examples of machine-readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

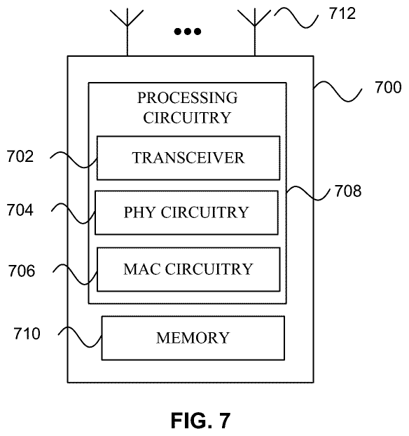

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA 504, HE AP 502, and/or a HE STA or HE AP. A HE STA 504, HE AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP 502, HE STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP 502 and/or HE STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mm Wave technology, communication between a station (e.g., the HE STAs 504 of FIG. 5 or wireless device 700) and an access point (e.g., the HE AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

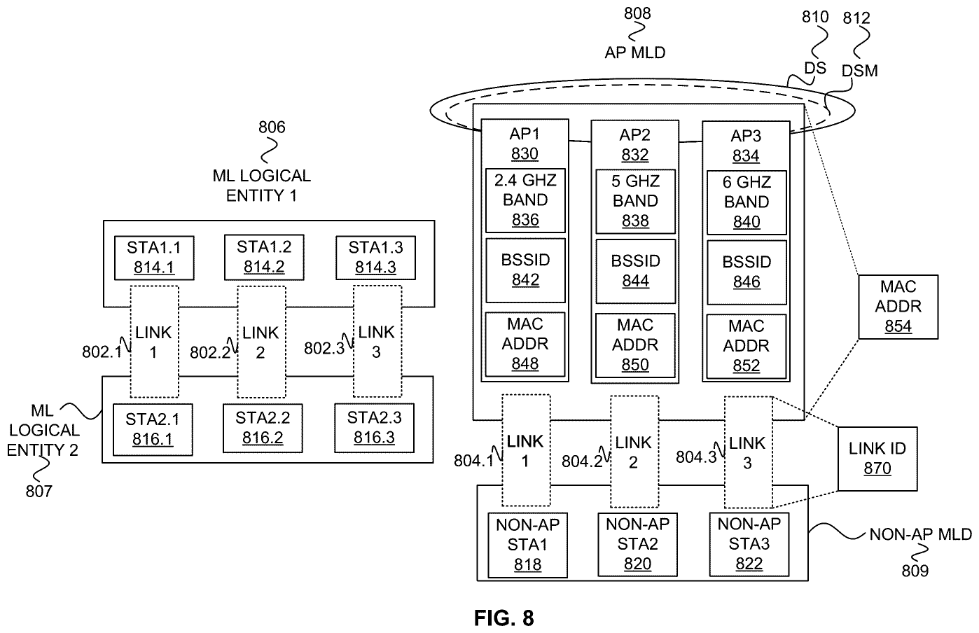

FIG. 8 illustrates multi-link devices (MLD) s 800, in accordance with some embodiments. Illustrated in FIG. 8 is ML logical entity 1 806, ML logical entity 2 807, AP MLD 808, and non-AP MLD 809. The ML logical entity 1 806 includes three STAs, STA1.1 814.1, STA1.2 814.2, and STA1.3 814.3 that operate in accordance with link 1 802.1, link 2 802.2, and link 3 802.3, respectively.

The Links are different frequency bands such as 2.4 GHz band, 5 GHz band, 6 GHz band, and so forth. ML logical entity 2 807 includes STA2.1 816.1, STA2.2 816.2, and STA2.3 816.3 that operate in accordance with link 1 802.1, link 2 802.2, and link 3 802.3, respectively. In some embodiments ML logical entity 1 806 and ML logical entity 2 807 operate in accordance with a mesh network. Using three links enables the ML logical entity 1 806 and ML logical entity 2 807 to operate using a greater bandwidth and more reliably as they can switch to using a different link if there is interference or if one link is superior due to operating conditions.

The distribution system (DS) 810 indicates how communications are distributed and the DS medium (DSM) 812 indicates the medium that is used for the DS 810, which in this case is the wireless spectrum.

AP MLD 808 includes AP1 830, AP2 832, and AP3 834 operating on link 1 804.1, link 2 804.2, and link 3 804.3, respectively. AP MLD 808 includes a MAC ADDR 854 that may be used by applications to transmit and receive data across one or more of AP1 830, AP2 832, and AP3 834. Each link may have an associated link ID. For example, as illustrated, link 3 804.3 has a link ID 870.

AP1 830, AP2 832, and AP3 834 includes a frequency band, which are 2.4 GHz band 836, 5 GHz band 838, and 6 GHz band 840, respectively. AP1 830, AP2 832, and AP3 834 includes different BSSIDs, which are BSSID 842, BSSID 844, and BSSID 846, respectively. AP1 830, AP2 832, and AP3 834 includes different media access control (MAC) address (addr), which are MAC adder 848, MAC addr 850, and MAC addr 852, respectively. The AP 502 is a AP MLD 808, in accordance with some embodiments. The STA 504 is a non-AP MLD 809, in accordance with some embodiments.

The non-AP MLD 809 includes non-AP STA1 818, non-AP STA2 820, and non-AP STA3 822. Each of the non-AP STAs may have MAC addresses and the non-AP MLD 809 may have a MAC address that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, or AP3 834, respectively, over link 1 804.1, link 2 804.2, and link 3 804.3, respectively.

A Multi-link device such as ML logical entity 1 806 or ML logical entity 2 807, is a logical entity that contains one or more STAs 814, 816. The ML logical entity 1 806 and ML logical entity 2 807 each has one MAC data service interface and primitives to the logical link control (LLC) and a single address associated with the interface, which can be used to communicate on the DSM 812. Multi-link logical entity allows STAs 814, 816 within the multi-link logical entity to have the same MAC address. In some embodiments a same MAC address is used for application layers and a different MAC address is used per link.

In infrastructure framework, AP MLD 808, includes APs 830, 832, 834, on one side, and non-AP MLD 809, which includes non-APs STAs 818, 820, 822 on the other side.

ML AP device (AP MLD): is a ML logical entity, where each STA within the multi-link logical entity is an EHT AP 502, in accordance with some embodiments. ML non-AP device (non-AP MLD) A multi-link logical entity, where each STA within the multi-link logical entity is a non-AP EHT STA 504. AP1 830, AP2 832, and AP3 834 may be operating on different bands and there may be fewer or more APs. There may be fewer or more STAs as part of the non-AP MLD 809.

In some embodiments the AP MLD 808 is termed an AP MLD or MLD. In some embodiments non-AP MLD 809 is termed a MLD or a non-AP MLD. Each AP (e.g., AP1 830, AP2 832, and AP3 834) of the MLD sends a beacon frame that includes: a description of its capabilities, operation elements, a basic description of the other AP of the same MLD that are collocated, which may be a report in a Reduced Neighbor Report element or another element such as a basic multi-link element. AP1 830, AP2 832, and AP3 834 transmitting information about the other APs in beacons and probe response frames enables STAs of non-AP MLDs to discover the APs of the AP MLD.

In a Wi-Fi network or IEEE 802.11 network, “channel switching” refers to a method where the AP 502 in an infrastructure networks or Group Owner (GO) in peer-to-peer networks determines to transition from a current channel to a new target channel. The AP 502 may determine to switch channels for lots of reasons such as interference.

Clients associate with APs 502. During the association process, the clients and APs 502 exchange capabilities through an association request frame and an association response frame. Often, mobile devices act as a STAs 504 or non-AP MLD 809 associate with an infrastructure AP 502 or AP MLD 808. The AP 502 or AP MLD 808 may be a mobile AP. Often, one or more of the STAs 504, non-AP MLD 809, AP 502, or AP MLD 808 operates using a single link. The AP MLD 808 may be a Mobile AP MLD. Often, the STAs 504, non-AP MLD 809, AP 502, or AP MLD 808 operate only on a particular channel (or channels) within one band. Additionally, the STAs 504, non-AP MLD 809, AP 502, or AP MLD 808 may be mobile devices that are battery operated and for which power consumption is limited.

A technical problem is how to improve the services or provisions provided to a STA 504 by an AP 502. In some embodiments, the technical problem is addressed by the STA 504 informing an AP 502 regarding expected uplink (UL) or downlink (DL) traffic of the STA 504 to or from the AP 502, so the AP 502 can better prioritization resource allocation and scheduling to and from the STA 504 to meet the needs of the STA 504.

In some embodiments, the technical problem is addressed by the STA 504 dynamically reporting its application parameters, which may be termed resource needs or service requirements, during a SCS session, e.g., report instantaneous data-rates, response time requirements, whether the STA 504 needs to be triggered for UL traffic, and so forth.

For UL resources, the AP 502 often will trigger the STA 504 with a periodicity providing UL allocations that match the reported traffic periodicity and data needs of the STA 504. In some embodiments, the technical problem is addressed by using a stream classification service (SCS) to include application traffic characteristics in a SCS Request sent from the STA to AP by including a new element called QoS Characteristics. In some embodiments, multiple profiles, which may be either triggered at the AP 502 by traffic patterns or which may be changed by information sent to the AP 502 from the STA 504, are used to change the request for resources. In some embodiments, the information is provided in frames sent to the AP 502 such as by changing a user priority (UP) or traffic identification (TID). In some embodiments, the STA 504 uses a QoS mechanism to dynamically inform the AP 502 regarding resource requirements of the current application, which enables the AP 502 to adapt to the current resource requirements (e.g., provide fewer or more UL resource using triggers), and it enables the AP 502 to adapt a relatively shorter duration.

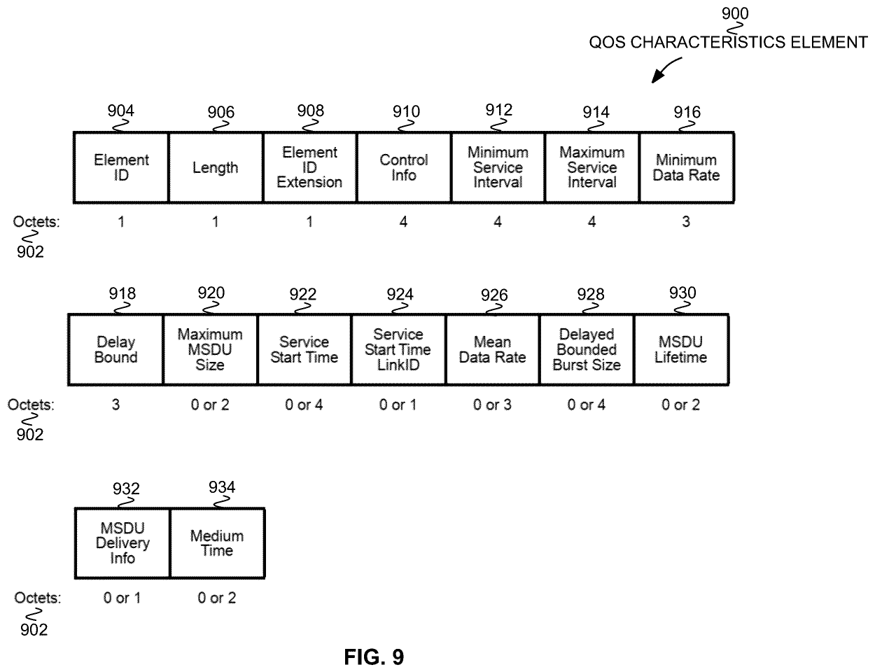

FIG. 9 illustrates a quality of service (QoS) characteristics element 900, in accordance with some embodiments. The QoS characteristics element 900 may as disclosed in a IEEE 802.11 communications standard. The QoS characteristics element 900 includes one or more of the following fields and may include additional fields as discussed herein: element identification (ID 904), length 906, element ID extension 908, control information (info 910), minimum service interval 912, maximum service interval 914, minimum data rate 916, delay bound 918, maximum MSDU size 920, service start time 922, service start time LinkID 924, mean data rate 926, delayed bounded burst size 928, MSDU lifetime 930, MSDU delivery info 932, and medium time 934. The octets 902 indicate the number of octets 902 in each field.

The QoS Characteristics element 900 is suitable for applications associated with the STA 504 where the traffic is mostly periodic, or the minimum (min) and maximum (max) service intervals (SI) do not very widely. If the conditions change, the STA 504 can only update the SCS stream by sending an SCS Request (not illustrated), which contains the QoS characteristics element 900, containing new traffic characteristics.

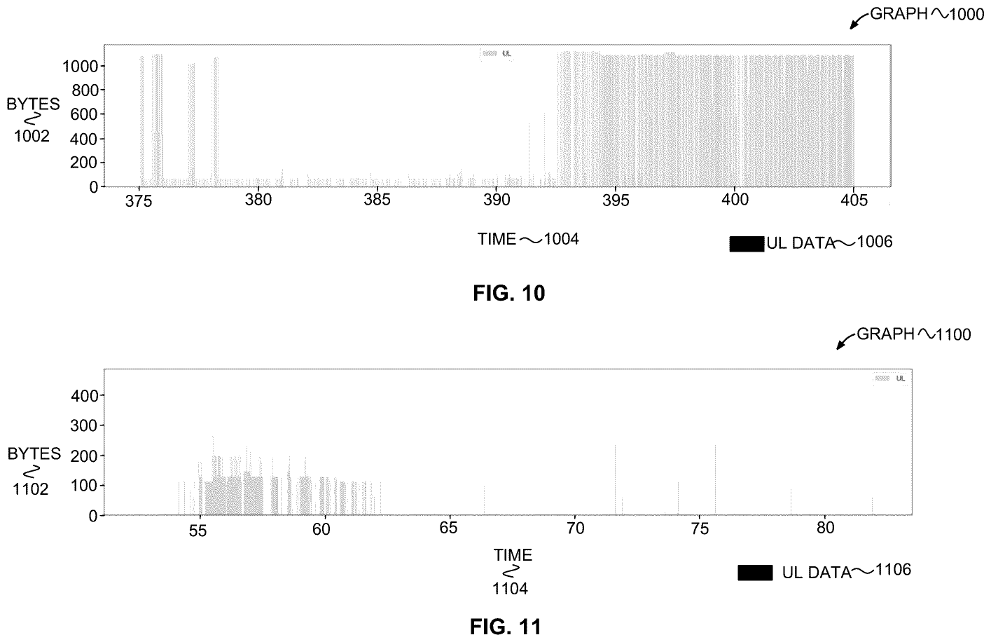

FIG. 10 illustrates a graph 1000 of a trace of UL traffic corresponding to slide-sharing during a video call. The graph 1000 include bytes 1002, time 1004, and UL data 1006. The trace of the application traffic data rate illustrates the data rate can vary widely based on user activity. The user of the video call is sharing a slide show.

FIG. 11 illustrates a graph 1100 of a trace collected for the UL traffic during a steam of a first-person shooter (FPS) game when there is lots of motion followed by no motion of the user within the virtual world. FIG. 11 includes bytes 1102, time 1104, and UL data 1106. In both FIGS. 10 and 11 there is a large difference in the service needs of the application (e.g., which may be resident on the STA 504), which may be based on the activity of the user. Although not illustrated, extended reality (XR) applications vary widely in their service needs including the rate of UL traffic depending on whether the user is moving their head fast enough or not.

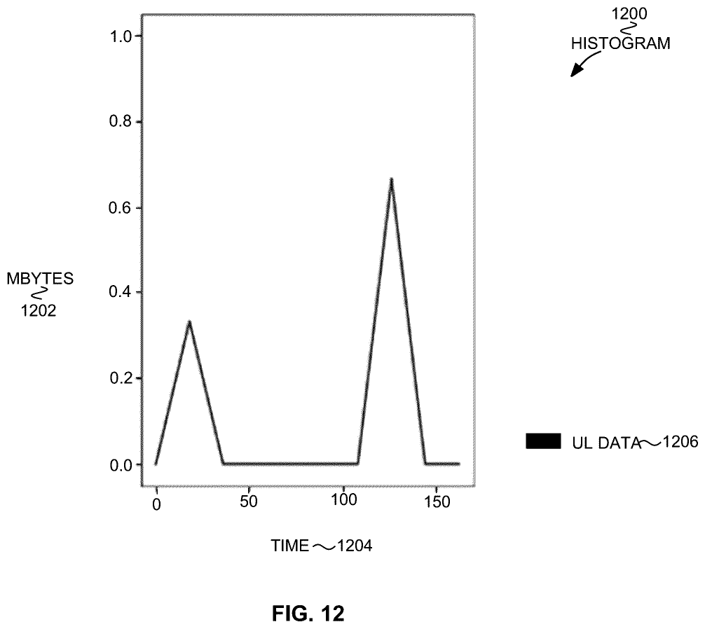

FIG. 12 illustrates a histogram 1200 of burst packet generation in UL carrying camera images, in accordance with some embodiments. The UL carrying camera images may be used by a peer STA 504 for generating pose estimates. FIG. 12 includes megabytes (MBYTES 1202), time 1204, and UL DATA 1206. FIG. 12 shows a histogram 1200 of traffic periodicity levels observed when using dynamic video input/output (VIO) offload. FIG. 12 illustrates that spikes at two different periodicity intervals with the 7.5 frame per second (fps) when the user is not moving much and one at 30 fps (default) when otherwise. The resource needs of the application vary greatly depending on the time.

In some embodiments, a dynamic report is transmitted (or signaled) to the AP 502 by the STA 504 using a new SCS Request each time the resource needs of the STA 504 change such as during application runtime. The SCS request is treated as a new SCS stream setup by AP 502. However, a SCS request (STA 504) and SCS response (AP 502) can consume UL and DL resource and time. Additionally, the SCS request/response, in some embodiments, does not include some information such as that the STA 504 does not need triggering (or no longer request triggering) for UL data when in low data rate periods of time. The AP 502 may suspend triggering.

In some embodiment, a min and max service interval is indicated in a frame such as the SCS request where the min and max service needs match the expected bounds of the application or service needs of the STA 504. However, the service needs of the STA 504 may vary widely so that the min and max service needs are inappropriate for the current needs resource needs of the STA 504 or application. The application spends varying amounts of time, which may be termed intervals, in states with different service needs, e.g., response times, UL data, and DL data. The min and max service needs for an entire application may be wasteful for some intervals of the application. As illustrated in FIGS. 10-12, the time spent by a user in a no motion or fast motion state can be several seconds. The resource or service requirements may also change depending on specific user and application.

In some embodiments, a STA 504 dynamically reports its application parameters, which may be termed resource needs or service requirements, during or within a SCS session, e.g., report one or more of: report instantaneous data-rates, response time requirements, and so forth, whether it needs to be triggered (for UL traffic), and so forth.

In some embodiments, the STA 504 dynamically reports its instantaneous QoS parameters, change in expected QoS, and/or triggering behavior (which may include an indication that no triggering is needed) to the AP 502.

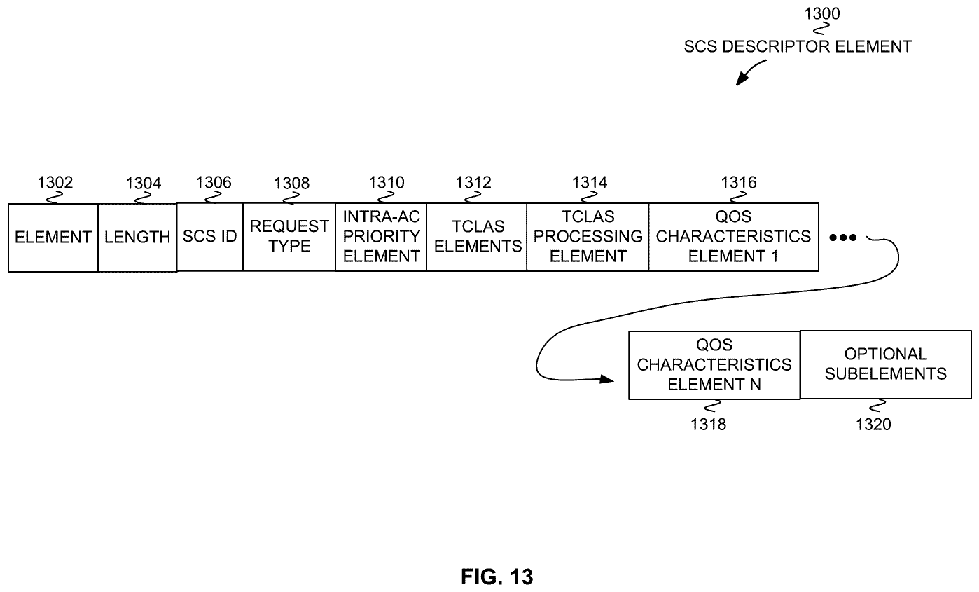

FIG. 13 illustrates a SCS descriptor element 1300, in accordance with some embodiments. FIG. 13 includes element 1302, length 1304, SCS ID 1306, request type 1308, intra-AC priority element 1310, TCLAS elements 1312, TCLAS processing element 1314, QoS characteristics element 1 1316, QoS characteristics element N 1318, and/or optional subelement 1320.

In some embodiments, each QoS Characteristics Element, QoS characteristics element 1 1316 through QoS characteristics element N 1318, correspond to a different QoS profile and each may be a QoS characteristics element 900 (which may have new fields as described herein). In some embodiments, the QoS characteristics element includes a field indicating a way to reference the QoS characteristic element.

In some embodiments during an initial SCS setup, the STA 504 includes multiple QoS profiles in the same SCS Request. For example, the STA 504 includes multiple QoS Characteristics elements in the same SCS Descriptor element. In some embodiments, the index of an associated QoS profile is derived from the order/position of the corresponding QoS Characteristics element in the list of QoS characteristic elements in the SCS Descriptor element.

If there are many QoS characteristic profiles, multiple SCS Descriptor elements 1300 with same SCS ID 1306 may be used to contain the additional QoS Characteristics elements.

In some embodiments, a QoS-profile, which may correspond to a QoS characteristic element, may additionally signal whether the STA 504 expects the AP 502 to trigger the STA 504 to provide UL resource unit when the traffic (generated or received by the STA 504) switches to this QoS profile.

In some embodiments, a QoS-profile may also include information to indicate the expected time when the profile will be active. For instance, based on past traffic profiling information, a device may be able to detect periods of activity associated with a given profile. This information may be included in the QoS Characteristic element and it can be used by the AP 502 to automatically update the status of the QoS-profile (active/inactive) without requiring a management frame exchange. For example, if the data rate from the STA 504 transgresses a minimum threshold or a maximum threshold, then the AP 502 may select another QoS-profile, which may correspond to a QoS characteristics element.

In some embodiments, the SCS Request frame from a STA could contain an additional QoS reporting subelement included within an SCS Descriptor element that contains the dynamic parameters such as current data rate, the triggering interval (or Minimum Service Interval) including a value for the latter that signals no triggering is needed without deleting the SCS stream.

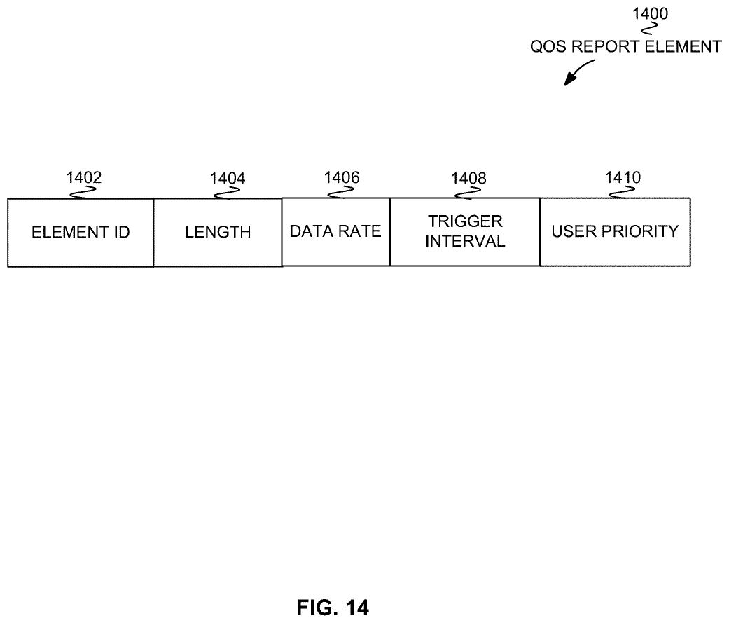

FIG. 14 illustrates a QoS report element 1400, in accordance with some embodiments. FIG. 14 includes element ID 1402, length 1404, data rate 1406, trigger interval 1408, and user priority 1410. The QoS report element 1400 may be included in the SCS request frame or another frame. The QoS report element 1400 may include one or more additional fields, and one or more field may not be included.

The example QoS Report element 1400 format includes current QoS values such as data rate 14-6, desired triggering interval 1408 and user priority 1410, for flows associated with an SC SID. A special value (e.g., 0) in the Trigger Interval 1408 may signal no triggering is needed temporarily.

In one embodiment the QoS reporting element 1400 may instead signal the index of a QoS profile previously signaled during SCS setup that matches the application's instantaneous traffic characteristics such as a 1 to indicate QoS characteristics element 1 1316 (or the QoS characteristic element may include a field for identification, in which case the QoS reporting element 1400 (or another field, frame, element) may signal the identification.

In one embodiment the SCS Request frame sent during initial SCS setup would itself contain a threshold data rate either in a new subelement in the SCS descriptor element 1300 or a new field in the QoS Characteristics element. The AP 502 is not expected to trigger the STA 504 below this data rate, in accordance with some embodiments.

In some embodiments, the SCS Request frame sent during initial SCS setup would itself contain an alternate User Priority 1410 field value either in a new subelement in the SCS Descriptor element 1300 or a new field in the QoS Characteristics element 900. During runtime, the STA 504 may determine the current data rate is not suitable for triggered channel access. As such it will switch its SCS stream to use the alternate user priority (UP). After the AP 502 receives UL traffic corresponding to this SCS stream marked with this new UP it stops triggering the STA 504 according to negotiated service intervals until it receives an UL frame with new UP or some other explicit signaling from STA 504.

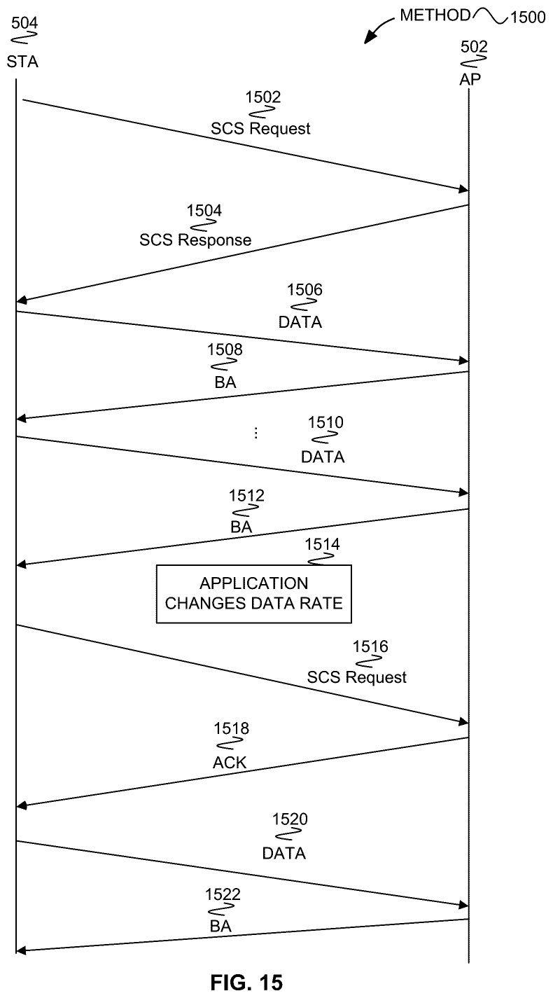

FIG. 15 illustrates an example method 1500 for signaling changes in QoS characteristics, in accordance with some embodiments. The method 1500 begins with the STA 504 sending or transmitting a SCS request 1502. The SCS request 1502 may include an SCSID-x, QoS Char Element-1<min SI=16 ms>, QoS Char Element 2<min SI=30 ms>, where the QoS Char Element indicates a QoS characteristics element 900, which may be the QoS character elements described in conjunction with the SCS descriptor element 1300. The method 1500 continues with the AP 502 sending a SCS response 1504 accepting the SCS request 1502. The method 1500 continues with data 1506 such as UL data at a 60 fps rate or every 16 ms to service the application running on the STA 504. The method 1500 continues with a block acknowledgement (BA 1508) from the AP 502. The method 1500 continues with more data 1510 in accordance with a 60 fps rate by the application running on the STA 504. The method 1500 continues with the AP 502 sending a BA 1512 acknowledging the data 1510.

The method 1500 continues with the application changes data rate 1514. The method 1500 continues with a SCS request 1516 where the SCS request 1516 indicates the same SCSID-x and a request to Switch to profile-2 due to the change in data rate. The method 1500 continues with the AP 502 sending an ACK 1518 acknowledging the SCS request 1516. The method 1500 continues with data 1520 at a 30 fps (every 30 ms) data rate. The method 1500 continues with the AP 502 transmitting a BA 1522 to acknowledge the data 1520.

FIG. 15 illustrates an example sequence of a STA 504 switching between multiple QoS profiles using a management frame. In this example, the application generates video traffic flow with data rates that switch between 60 fps and 30 fps. Once the data rate changes the STA 504 informs the AP 502 by transmitting an SCS request 1516 frame where the SCS request 1516 frame indicates that the AP 502 should switch to profile 2, which may correspond to a QoS characteristics element as illustrated in FIG. 13. The indication to switch to profile 2 may be in accordance with one of the mechanisms described herein such as a change in UP or a new field.

The method 1500 may be performed by an apparatus for a STA 504, an apparatus for a non-AP MLD 809, an apparatus for an AP 502, or an apparatus for an AP MLD 808, and/or another device or apparatus disclosed herein. The method 1500 may include one or more additional instructions. The method 1500 may be performed in a different order. One or more of the operations of method 1500 may be optional.

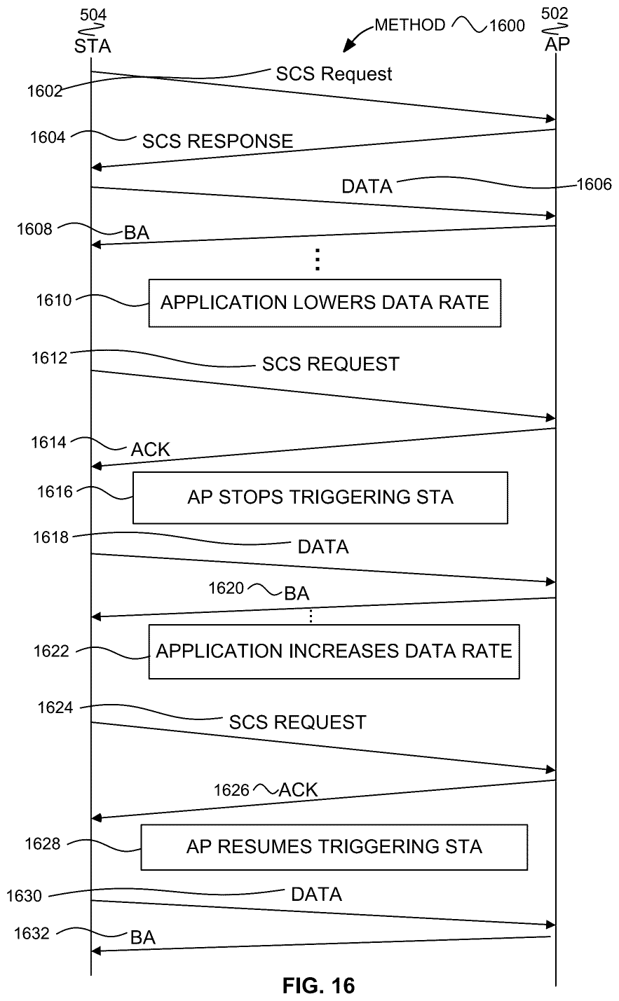

FIG. 16 illustrates a method 1600 for signaling changes in QoS characteristics, in accordance with some embodiments. FIG. 16 shows an example of QoS report element 1400 usage where the STA 504 reports when its application data rate changes and whether it needs to be triggered or not. Accordingly, the AP 502 stops triggering the STA 504 when the application generates traffic sparsely (e.g., in case of a gaming application the user is being temporarily inactive). Example of application using QoS Report element 1400 to switch between periods of low data rate and high. During the low data rates, the STA 504 is not triggered by the AP 502.

The method 1600 begins with the STA 504 transmitting a SCS request 1602. The SCS request 1602 includes <SCSID-x, QoS Char Element-1<min SI=20 ms, data rate =50 Kbps>. The method 1600 continues with the AP 502 transmitting an SCS response 1604 acknowledging the set-up of the SCS stream.

The method 1600 continues with the STA 504 sending data 1606 in a TB PPDU at 50 KBPS. Where the TB PPDU is in response to a trigger frame (not illustrated) sent by the AP 502. The method 1600 continues with the AP 502 sending a BA 1608 acknowledging the data 1606.

The method 1600 continues with the application lowers data rate 1610, e.g., there is no movement by a user of a game. The method 1600 continues with the STA 504 transmitting a SCS request 1612. The SCS request 1612 includes <SCSID-x, QoS Report<Data-rate=3 kbps, trigger interval=0>. The AP 502 responds by sending an ACK 16114. The method 1600 continues with the AP 502 transmitting an ACK 1614 in response to the SCS request 1612.

The method 1600 continues with AP stops triggering STA 1616. In response to the SCS request 1612, the AP 502 stops triggering the STA 504. The method 1600 continues with the STA 504 transmitting data 1618 in a single user (SU) PPDU using EDCA at 3 KBPS. The STA 504 sends data by gaining control of the wireless medium using EDCA and sending an SU PPDU to the AP 502. The AP 502 responds by sending a BA 1620 to the STA 504. The method 1600 continues with the AP 502 transmitting a BA 1620 to acknowledge the data.

The method 1600 continues with the application increase data rate 1622, e.g., there is frequent motion in game by the user. The method 1600 continues with the STA 504 sending an SCS request 1624, which includes (SCSID-x, QoS Report<Data-rate=50 kbps, trigger interval=20 ms>). The method 1600 continues with the AP 502 responding by sending an ACK 1626. The method 1600 continues with the AP resumes triggering STA 1628, e.g., for this SCS flow the AP 502 sends trigger frames as appropriate for the SCS request 1624. The method 1600 continues with the STA 504 sending data 1630, e.g., in TB PPDU using EDCA @50 kbps, which is in response to trigger frame (not illustrated) from the AP 502. The method 1600 continues with the AP 502 sending, in response, a BA 1632. The method 1600 may be performed by an apparatus for a STA 504, an apparatus for a non-AP MLD 809, an apparatus for an AP 502, or an apparatus for an AP MLD 808, and/or another device or apparatus disclosed herein. The method 1600 may include one or more additional instructions. The method 1600 may be performed in a different order. One or more of the operations of method 1600 may be optional.

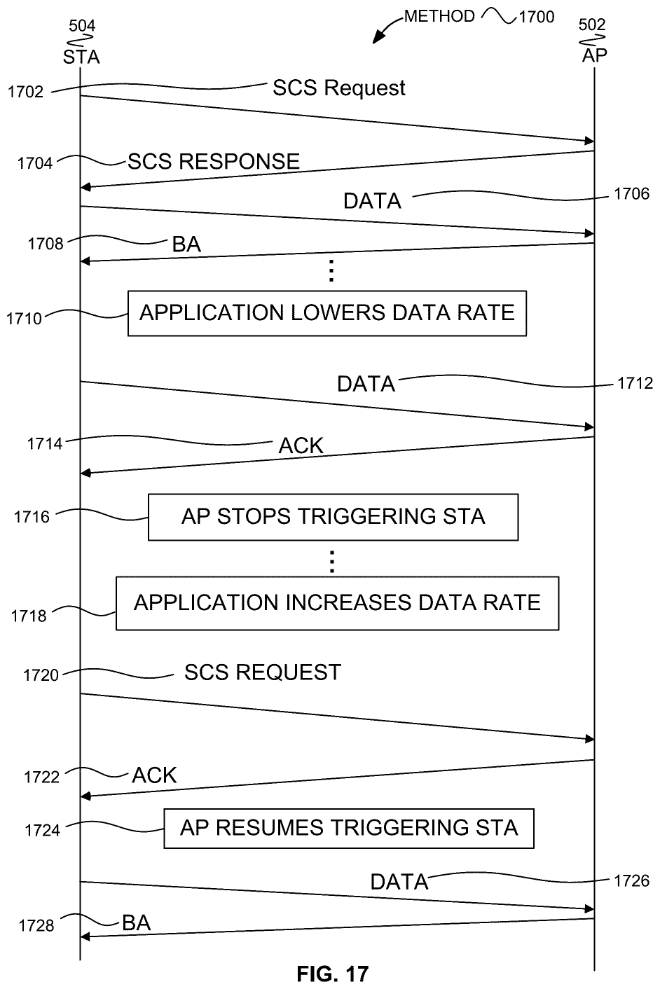

FIG. 17 illustrates a method 1700 for signaling changes in QoS characteristics, in accordance with some embodiments. FIG. 17 illustrates an example of a STA 504 switching its UL application traffic to a different TID when the STA 504 does not need or want to get triggered anymore for this QoS flow due to the STA 504 having a low data rate. FIG. 17 illustrates an example of application switching its TID when the STA 504 wants to stop the AP 502 from sending trigger frames to the STA 504.

Method 1700 begins with the STA 504 sending an SCS request 1702, e.g., (SCSID-x, QoS Char Element-1<UP=m>, Alternate UP=n). The AP 502 responds by sending an SCS response 1704. The method 1700 continues with the STA 504 sending data 1706, e.g., data is sent in response to a trigger frame (not illustrated) from the AP 502 in a TB PPDU, with an indication of an UP=m). The method 1700 continues with the AP sending a BA 1708 in response to the data 1706.

The method 1700 continues with the application lowers data rate 1710, e.g., there may be little or no motion in a video game. The method 1700 continues with the STA 504 transmitting data 1712, e.g., the STA 504 sends data in a SU PPDU (UP=n), which may be without a trigger frame from the AP 502. The method 1700 continues with the AP 502 responding by transmitting an ACK 1714.

The method 1700 continues with the AP stop triggering STA 1716, e.g., the AP 502 stops triggering the STA 504 for this flow, which may be in response to the UP being set to N.

The method 1700 continues with the application increases data rate 1718, e.g., the user is making frequent motions in the video game. The method 1700 continues with the STA 504 transmitting an SCS request 1720, e.g., (SCSID-x, QoS Report<trigger interval=20 ms>). The AP 502 responds with an ACK 1722.

The method 1700 continues with AP resumes triggering STA 1724, e.g., the AP 502 in response to the SCS request 1720 starts triggering the STA 504.

The method 1700 continues with the STA 504 transmitting data 1726, e.g., a dynamic QoS report wherein we identified a set of parameters that can change during runtime. The method 1700 continues with the AP 502 transmitting an BA 1728 in response to the data 1726.

The method 1700 may be performed by an apparatus for a STA 504, an apparatus for a non-AP MLD 809, an apparatus for an AP 502, or an apparatus for an AP MLD 808, and/or another device or apparatus disclosed herein. The method 1700 may include one or more additional instructions. The method 1700 may be performed in a different order. One or more of the operations of method 1700 may be optional.

The STA 504 and AP 502 disclosed herein may each be one of: an access point (AP), a non-AP STA, an AP of an AP of a multiple link device (MLD), or a non-AP STA of an MLD.

In some embodiments, one or more methods described herein enable network resources to be adapted between two peer STAs (or a STA and AP) based on signaling dynamic changes in the application state relative to when a QoS session was established.

For example, a SCS Request/Response frame exchange may be used to signal the change in QoS characteristics. Real-time and low latency applications, e.g., control systems, robotics, augmented reality (AR) or virtual reality (VR), use dynamic signaling of QoS capabilities (or setting up conditions the AP may use) and/or the network capacity to improve the use of the wireless medium.

Often, QoS signaling solutions in Wi-Fi are static, i.e., assume the traffic requirements for a flow are constant or change only at a very large time scale. Dynamic QoS signaling enabling signaling changing in the QoS characteristics on a smaller time scale.

In some embodiments, dynamic QoS signaling is disclosed for Wi-Fi. The dynamic QoS signaling enable enhanced resource utilization in meeting QoS requirements for low latency and other applications in the network, in accordance with some embodiments.

In some embodiments, dynamic QoS signaling enable enhancements in resource utilization and network capacity. Applications do not always need worst-case services from peers or the AP 502.

In one embodiment the dynamic QoS information consists of a set of parameters including one or more of the following: Packet Delivery Ratio, Latency Bound, Jitter, Data rate, Tolerance to loss, or Criticality. One or more of these parameters may be included in the elements and frames disclosed herein.

In some embodiments, the dynamic QoS information or characteristics is carried in the A-control (Ctrl) field of a data frame. In some embodiments, the dynamic QoS information or characteristics may apply to all traffic that has the same TID in the containing QoS Data frame. In some embodiments, the dynamic QoS information may also specify a stream ID for which it applies, e.g., SCSID.

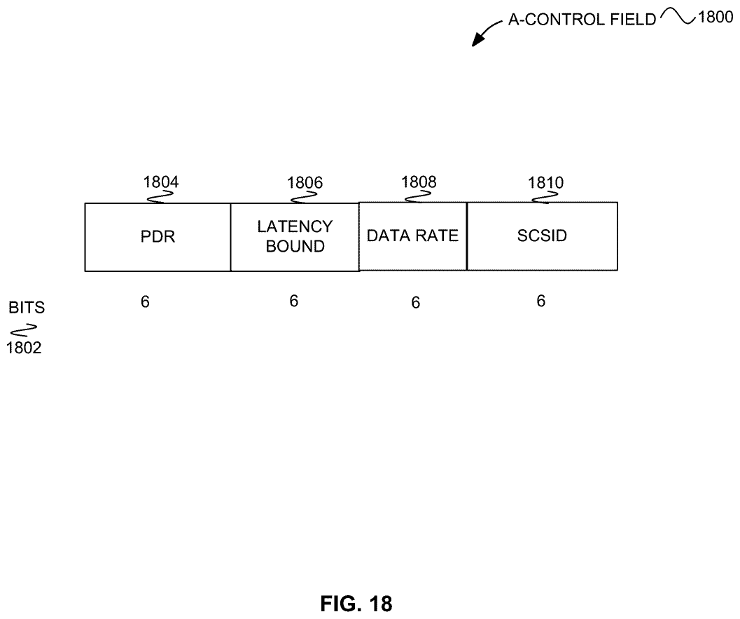

FIG. 18 illustrates an A-control field 1800, in accordance with some embodiments. The A-control field 1800 includes dynamic QoS information or characteristics that includes packet deliver rate (PDR) 1804, latency bound 1806, data rate 1808, and SCSID 1810. The bits 1802 indicates a number of bits for the fields, which may be different numbers.

In some embodiments, dynamic QoS information may be carried in a control information 1900 frame. In some embodiments, the dynamic QoS information carries one or more parameters that are changed with their corresponding value. In some embodiments, a field/subfield at the beginning will carry the index or bitmap of parameters that are going to change and hence needs to be signaled.

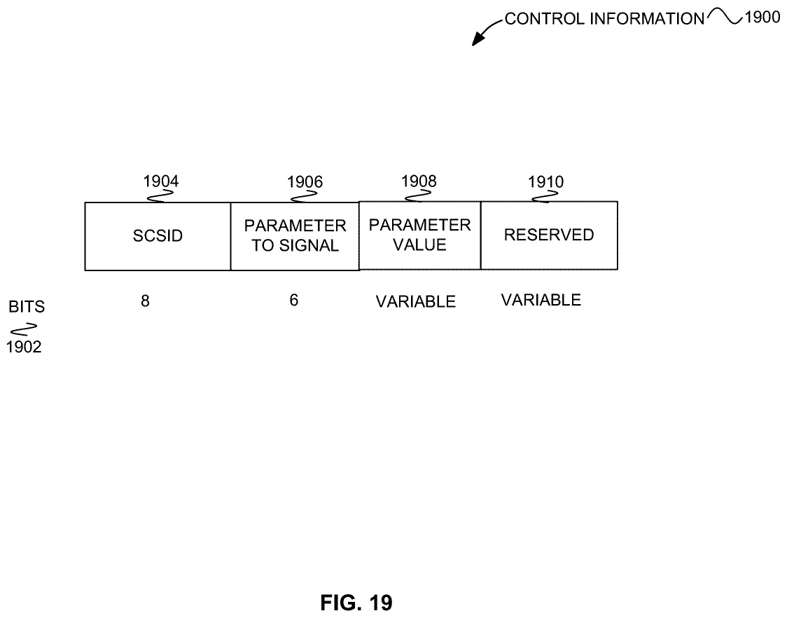

FIG. 19 illustrates control information 1900, in accordance with some embodiments. The control information 1900 includes a SCSID 1904, parameter to signal 1906, parameter value 1908, and reserved 1910. The bits 1902 indicate a number of bits for the fields, where the number of bits may be different.

The parameter to signal 1906 signals one or more parameters such as with a bit map that are to be changed. The parameter value 1908 indicates a new value for the parameter. In some embodiments, the parameters to signal 1906 may include more than one parameter, in which case there is more than one parameter value 1908 field. In some embodiments, the control information 1900 is an element.

The SCSID 1904 indicates the session corresponding to given SCSID where the changed parameter value 1908 is to be applied.

In one embodiment during a stream session establishment between two peer STAs, they negotiate a set of feasible QoS parameters, each identified by a corresponding index, that are likely to occur during the operation. During the operation dynamic QoS can then be signaled by one peer STA specifying the index of the new QoS parameter.

In some embodiments, the dynamic QoS info is valid for a signaled time period after which the QoS session that was initially negotiated or updated via Management frames is assumed to take effect. In some embodiments, the dynamic QoS information is signaled in a data frame, e.g., as part of AControl, and may include a time period for which the new parameters are valid. In some embodiments, the dynamic QoS information is valid until new QoS parameters are signaled either dynamically or by a new management frame exchange such as a new SCS request/response.

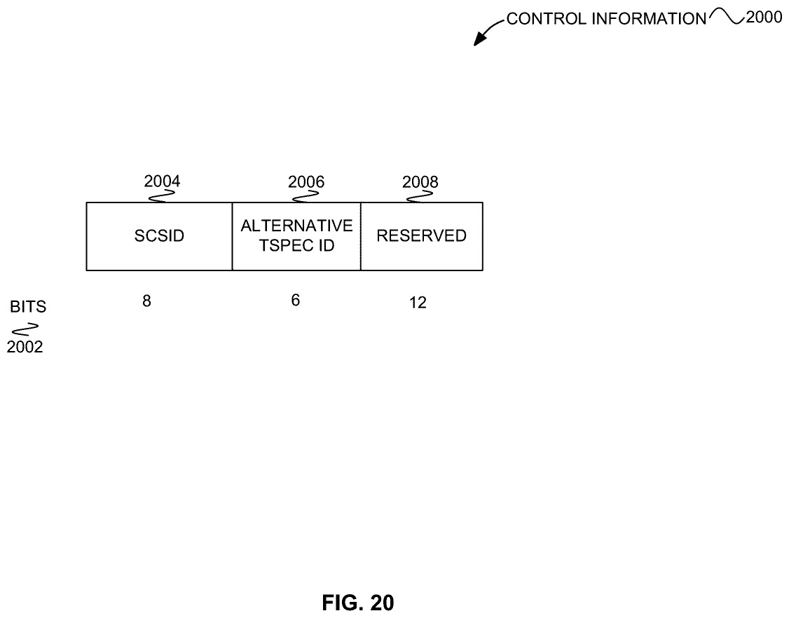

FIG. 20 illustrates control information 2000, in accordance with some embodiments. FIG. 20 indicates example control information for an A-Control field carrying dynamic QoS information via TSPEC ID. FIG. 20 includes SCSID 2004, alternative TSPEC ID 2006, and reserved 2008. Bits 2002 indicates an embodiment of the number of bits for the fields, where the number of bits may be different. The TSPEC ID 2006 indicates an alternative set of QoS characteristics (or information) to be used for the stream corresponding to SCSID 2004.

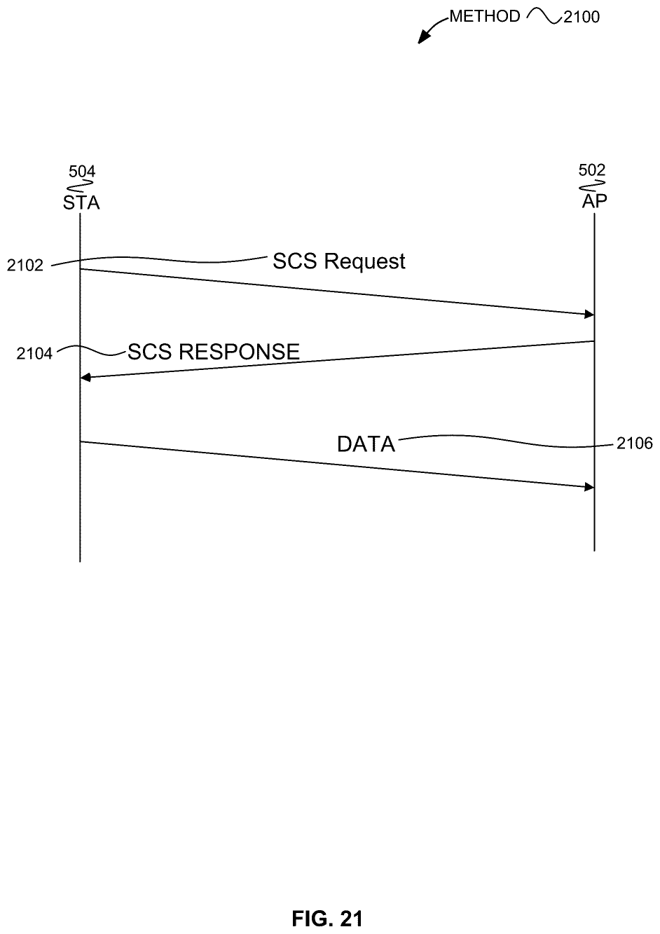

FIG. 21 illustrates a method 2100 for signaling changes in QoS characteristics, in accordance with some embodiments. The method 2100 begins with the STA 504 transmitting a SCS request 2102, which may include a SCSID, TSPEC 1, latency bound=10 ms, UL; TSPEC 2, latency bound=40 ms, UL. Here two QoS information or characteristics are defined by TSPEC 1 and TSPEC 2.

The method 2100 continues with the AP 502 transmitting a SCS response adding the stream with SCSID indicated in the SCS request 2102.

The AP 502 meets the requested 10 ms UL QoS characteristic requested by the STA 504 as part of TSPEC 2. For example, the AP 502 may send trigger frames to the STA 504 with UL resource units.

The STA 504 then transmits data 2106 such as A-ctrl: dynamic QoS information, with an indication of TSPEC ID 2, and SCSID of the initial SCS request 2102. The data 2106 indicates the STA 504 is switching the QoS characteristics or information to those corresponding to TSPEC 2 with a latency bound of 40 ms UL. The AP 502 then meets the news latency bound of 40 ms UL with subsequent signaling. The SCS request 2102 may include additional parameters such as a QoS characteristics element. The signaling to switch to different QoS characteristics or information may be performed differently.

In some embodiments, polling is used to collect change of QoS information. In some embodiments, the AP 502 polls a STA 504 to see if the STA 504 has any updates to an ongoing QoS stream session. In some embodiments, a polled STA 504 may signal that it has an update to an existing session by raising energy at a designated RU or tone. In some embodiments, the AP 502 may send a TF variant asking for specific QoS on an SCSID.

In some embodiments, the response from a polled STA can contain the entire dynamic QoS information either in a new Ctrl frame, an A-Ctrl field, a QoS characteristics element, an existing management frame, or a new management frame. This may be used when a few frames corresponding to the stream need improved/special QoS treatment.

In some embodiments, the STA 504 may include the dynamic QoS information in a Data or management frame sent in a trigger based (TB) PPDU as a response to a Basic or BSRP TF. This may be used when a sequence of frames or frames transmitted within a certain time span corresponding to the SCSID stream requires improved/special QoS treatment.

In some embodiments, if improved/special QoS treatment is needed for certain frames corresponding to the SCSID stream, where the improved/special QoS treatment is based on certain tags in the application header (layer-4 or above), the tags in the application header can be specified as an additional TCLAS element such as class 10, which may be defined in the SCS setup for the stream.

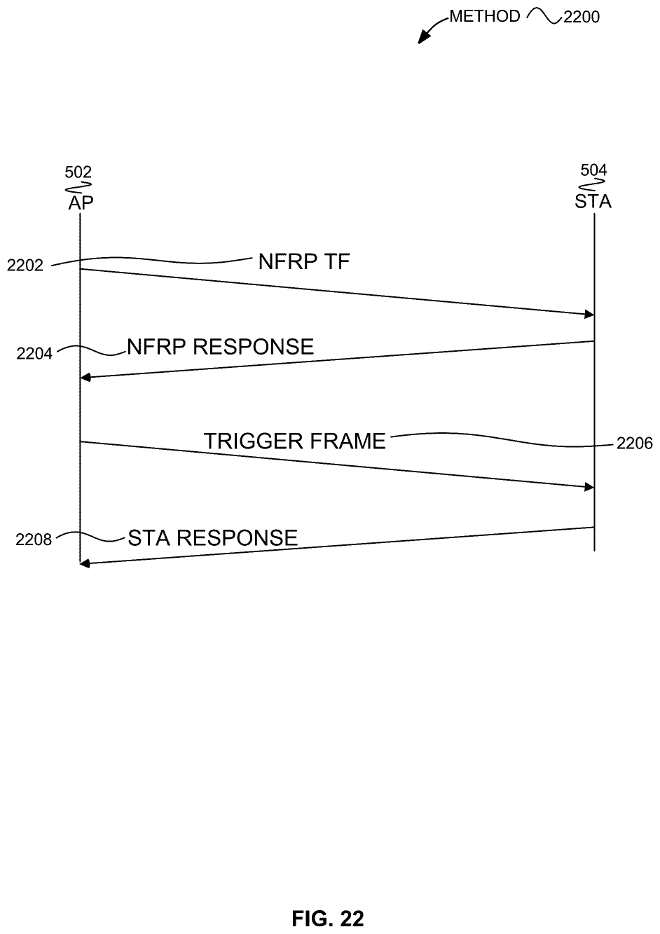

FIG. 22 illustrates a method 2200 for signaling changes in QoS characteristics, in accordance with some embodiments. FIG. 22 illustrates an example of two step polling of a STA 504 by an AP 502 to collect any information about dynamic change in QoS. This is useful in a fully scheduled mode and can be performed in the polling phase of a TXOP exchange such as a S-TXOP exchange.

The method 2200 begins the AP 502 transmitting NFRP TF 2202 to request for changes in QoS.

The method 2200 continues with the STA 504 transmitting a NFRP response 2204 signaling the STA 504 needs to report a change. The method 2200 continues with the AP 502 transmitting a trigger frame 2206 such as a BSRP, basic, or new trigger frame requesting details regarding the change in the QoS information or characteristics. The AP 502 may trigger multiple STA 504 in both NFRP TF 2202 and trigger frame 2206.

The method 2200 continues with the STA 504 transmitting STA response 2208 where the response may be a TB PPDU including the change or a new set of QoS information or characteristics.

FIG. 22 is an example of a two-step signaling method for dynamic change in QoS information in an AP 502 scheduled mode. The first exchange informs AP 502 about which STAs require change in dynamic QoS. In the second exchange AP 502 requests detailed responses from the set of STAs who signaled a change during the first frame exchange.

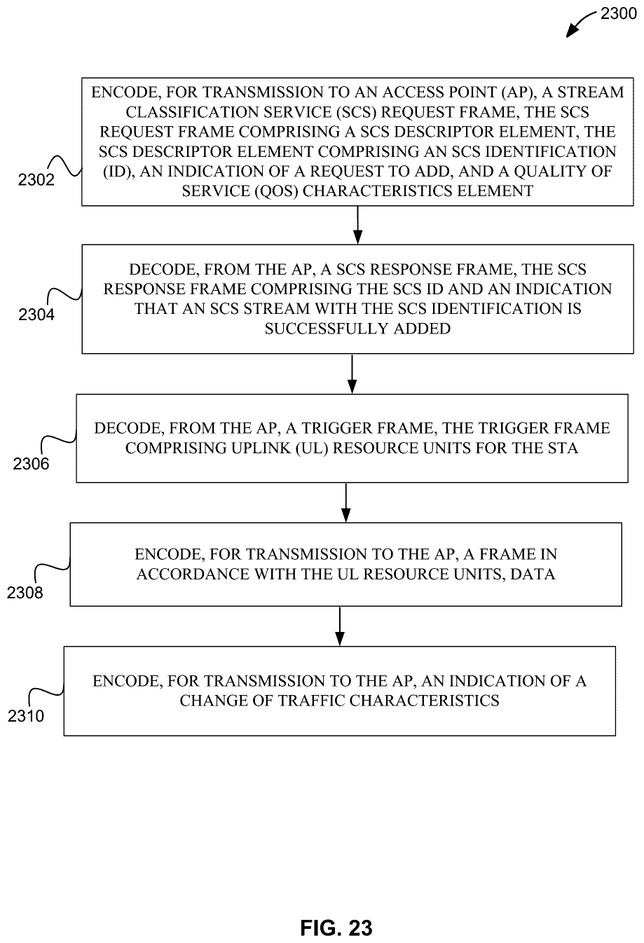

FIG. 23 illustrates a method 2300 for signaling changes in QoS characteristics, in accordance with some embodiments. The method 2300 beings at operation 2302 with encoding a SCS request frame, the SCS request frame comprising a SCS descriptor element, the SCS descriptor element comprising an SCS identification (ID), an indication of a request to add, and a quality of service (QoS) characteristics element. For example, STA 504 transmits SCS request 2102 of FIG. 21, SCS request 1702 of FIG. 17, SCS request 1602 of FIG. 16, or SCS request 1502 of FIG. 15.

The method 2300 continues at operation 2304 with decoding a SCS response frame, the SCS response frame comprising the SCS ID and an indication that an SCS stream with the SCS identification is successfully added. For example, the STA 504 decodes SCS response 2104 of FIG. 21, SCS response 1704 of FIG. 17, SCS response 1604 of FIG. 16, or SCS response 1504 of FIG. 15.

The method 2300 continues at operation 2306 with decoding a trigger frame, the trigger frame comprising uplink (UL) resource units for the STA. For example, STA 504 decodes trigger frame 2206 of FIG. 22, STA 504 decodes trigger frame (not illustrated) before data 1706 and data 1726 of FIG. 17. STA 504 decodes trigger frame (not illustrated) before data 1606 and data 1630 of FIG. 16. STA 504 decodes trigger frame (not illustrated) before data 1506 and data 1510 of FIG. 15.

The method 2300 continues at operation 2308 with encoding a frame in accordance with the UL resource units, data. For example, STA 504 encodes STA response 2208 of FIG. 22. STA 504 encodes data 2106 of FIG. 21. STA 504 encodes data 1706 and data 1726 of FIG. 17. STA 504 encodes data 1606 and data 1630.

The method 2300 continues at operation 2310 with encoding an indication of a change of traffic characteristics. For example, STA 504 encodes STA response 2208 of FIG. 22. STA 504 encodes data 2106 of FIG. 21. STA 504 encodes SCS request 1720 and data 1712 of FIG. 17. STA 504 encodes SCS request 1612 and SCS request 1624. STA 504 encodes SCS request 1516 of FIG. 15.

The method 2300 may be performed by an apparatus for a STA 504, an apparatus for a non-AP MLD 809, an apparatus for an AP 502, or an apparatus for an AP MLD 808, and/or another device or apparatus disclosed herein. The method 2300 may include one or more additional instructions. The method 2300 may be performed in a different order. One or more of the operations of method 2300 may be optional.

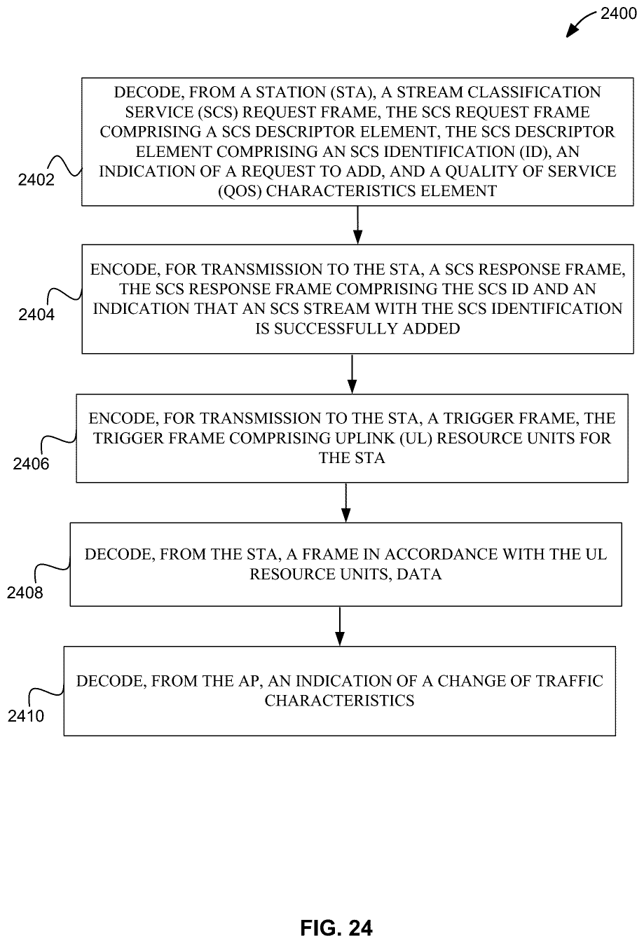

FIG. 24 illustrates a method 2400 for signaling changes in QoS characteristics, in accordance with some embodiments. The method 2400 begins at operation 2402 with decoding, from a STA, a SCS request frame, the SCS request frame comprising a SCS descriptor element, the SCS descriptor element comprising an SCS identification (ID), an indication of a request to add, and a QoS characteristics element. For example, AP 502 decodes SCS request 2102 of FIG. 21, SCS request 1702 of FIG. 17, SCS request 1602 of FIG. 16, or SCS request 1502 of FIG. 15.

The method 2400 continues at operation 2404 with encoding, for transmission to the STA, a SCS response frame, the SCS response frame comprising the SCS ID and an indication that an SCS stream with the SCS identification is successfully added. For example, the AP 502 encodes SCS response 2104 of FIG. 21, SCS response 1704 of FIG. 17, SCS response 1604 of FIG. 16, or SCS response 1504 of FIG. 15.

The method 2400 continues at operation 2406 with encoding, for transmission to the STA, a trigger frame, the trigger frame comprising uplink (UL) resource units for the STA. For example, AP 502 encodes trigger frame 2206 of FIG. 22, STA 504 decodes trigger frame (not illustrated) before data 1706 and data 1726 of FIG. 17. STA 504 decodes trigger frame (not illustrated) before data 1606 and data 1630 of FIG. 16. STA 504 decodes trigger frame (not illustrated) before data 1506 and data 1510 of FIG. 15.

The method 2400 continues at operation 2408 with decoding, from the STA, a frame in accordance with the UL resource units, data. For example, AP 502 dencodes STA response 2208 of FIG. 22. STA 504 encodes data 2106 of FIG. 21. STA 504 encodes data 1706 and data 1726 of FIG. 17. STA 504 encodes data 1606 and data 1630.

The method 2400 continues at operation 2410 with decoding, from the AP, an indication of a change of traffic characteristics. For example, AP 502 decodes STA response 2208 of FIG. 22. STA 504 encodes data 2106 of FIG. 21. STA 504 encodes SCS request 1720 and data 1712 of FIG. 17. STA 504 encodes SCS request 1612 and SCS request 1624. STA 504 encodes SCS request 1516 of FIG. 15.

The method 2400 may be performed by an apparatus for a STA 504, an apparatus for a non-AP MLD 809, an apparatus for an AP 502, or an apparatus for an AP MLD 808, and/or another device or apparatus disclosed herein. The method 2400 may include one or more additional instructions. The method 2400 may be performed in a different order. One or more of the operations of method 2400 may be optional. The Abstract is provided to comply with 37 C.F.R. Section 1.72(b)

requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA), the apparatus comprising memory; and processing circuitry coupled to the memory, the processing circuitry configured to:
encode, for transmission to an access point (AP), a stream classification service (SCS) request frame, the SCS request frame comprising a SCS descriptor element, the SCS descriptor element comprising an SCS identification (ID), an indication of a request to add, and a quality of service (QoS) characteristics element;
decode, from the AP, a SCS response frame, the SCS response frame comprising the SCS ID and an indication that an SCS stream with the SCS identification is successfully added;
decode, from the AP, a trigger frame, the trigger frame comprising uplink (UL) resource units for the STA;
encode, for transmission to the AP, a frame in accordance with the UL resource units, data; and
encode, for transmission to the AP, an indication of a change of traffic characteristics.

2. The apparatus of claim 1, wherein the QoS characteristics element comprises an indication of whether the STA is requesting the AP to allocate UL resource units in trigger frames for the STA.

3. The apparatus of claim 1, wherein the QoS characteristics element is a first QoS characteristics element, the SCS descriptor element is encoded with a second QoS characteristics elements, and the indication of the change of traffic characteristics is an indication for the AP to use the second QoS characteristics element.

4. The apparatus of claim 3, wherein the indication for the AP to use the second QoS characteristics element comprises a QoS report element, the QoS report element comprising an indication of an index, the index indicating the second QoS characteristics element.

5. The apparatus of claim 1, wherein the QoS characteristics element comprises an indication of when the QoS characteristics element is active and when the QoS characteristic element is inactive.

6. The apparatus of claim 1, wherein the indication of the change of traffic characteristics comprises a QoS report element, the QoS report element comprising a current data rate, a triggering interval or minimum service interval, and a user priority (UP).

7. The apparatus of claim 1, wherein the SCS request frame further comprises an indication of a data rate, wherein the STA is not requesting to be triggered for data rates below the data rate.

8. The apparatus of claim 1, wherein the SCS request frame comprises an indication of a user priority (UP) and an indication of an alternative UP, and wherein the indication of the change of traffic characteristics is data encoded in a media access control (MAC) protocol data unit, with an indication the data has the alternative UP.

9. The apparatus of claim 8, wherein the alternative UP indicates the STA is not requesting the AP to transmit trigger frames for the STA and the UP indicates the STA is requesting that the AP transmit the trigger frames for the STA.

10. The apparatus of claim 1, wherein the indication of the change of traffic characteristics indicates the STA is not requesting triggering.

11. The apparatus of claim 10, wherein the indication of the change of traffic characteristics is a first indication, and wherein the processing circuitry is further configured to:
encode, for transmission to the AP, a frame comprising a second indication of a change of traffic characteristics.

12. The apparatus of claim 11, wherein the AP suspends triggering the STA after receiving the first indication and resumes triggering after the receiving the second indication.

13. The apparatus of claim 1, wherein the STA and AP are each one of: an access point (AP), a non-AP STA, an AP of an AP of a multiple link device (MLD), or a non-AP STA of an MLD.

14. The apparatus of claim 1, further comprising transceiver circuitry coupled to the processing circuitry, wherein the transceiver circuitry is coupled to two or more microstrip antennas for receiving signaling in accordance with a multiple-input multiple-output (MIMO) technique, or the transceiver circuitry is coupled to the processing circuitry, the transceiver circuitry coupled to two or more patch antennas for receiving signaling in accordance with a multiple-input multiple-output (MIMO) technique.

15. A non-transitory computer-readable storage medium including instructions that, when processed by one or more processors, configure a first station (STA) to perform operations comprising:
encode, for transmission to an access point (AP), a stream classification service (SCS) request frame, the SCS request frame comprising a SCS descriptor element, the SCS descriptor element comprising an SCS identification (ID), an indication of a request to add, and a quality of service (QoS) characteristics element;
decode, from the AP, a SCS response frame, the SCS response frame comprising the SCS ID and an indication that an SCS stream with the SCS identification is successfully added;
decode, from the AP, a trigger frame, the trigger frame comprising uplink (UL) resource units for the STA;
encode, for transmission to the AP, a frame in accordance with the UL resource units, data; and
encode, for transmission to the AP, an indication of a change of traffic characteristics.

16. The non-transitory computer-readable storage medium of claim 15, wherein the QoS characteristics element comprises an indication of whether the STA is requesting the AP to allocate UL resource units in trigger frames for the STA.

17. The non-transitory computer-readable storage medium of claim 15, wherein the QoS characteristics element is a first QoS characteristics element, the SCS descriptor element is encoded with a second QoS characteristics elements, and the indication of the change of traffic characteristics is an indication for the AP to use the second QoS characteristics element.

18. An apparatus for an access point (AP), the apparatus comprising memory; and processing circuitry coupled to the memory, the processing circuitry configured to:
decode, from a station (STA), a stream classification service (SCS) request frame, the SCS request frame comprising a SCS descriptor element, the SCS descriptor element comprising an SCS identification (ID), an indication of a request to add, and a quality of service (QoS) characteristics element;
encode, for transmission to the STA, a SCS response frame, the SCS response frame comprising the SCS ID and an indication that an SCS stream with the SCS identification is successfully added;
encode, for transmission to the STA, a trigger frame, the trigger frame comprising uplink (UL) resource units for the STA;
decode, from the STA, a frame in accordance with the UL resource units, data; and
decode, from the AP, an indication of a change of traffic characteristics.

19. The apparatus of claim 1, wherein the indication of the change of traffic characteristics indicates the STA is no longer expecting the AP to trigger the STA.

20. The apparatus of claim 1, wherein the QoS characteristics element is a first QoS characteristics element, the SCS descriptor element is encoded with a second QoS characteristics elements, and the indication of the change of traffic characteristics is an indication for the AP to use the second QoS characteristics element.
